(19) United States
(12) Patent Application Publication
(10) Pub. No.: US 2026/0183920 A1
(43) Pub. Date: Jul. 2, 2026

(54) Spindle Locking Device, Tool Holder, and Assembly Method for Assembling a Tool Holder

(71) Applicant: Robert Bosch GmbH, Stuttgart (DE)

(72) Inventors: Michael Wall, Stuttgart (DE); Lukas Fuchs, Stuttgart (DE)

(21) Appl. No.: 18/858,106

(22) PCT Filed: Apr. 19, 2023
(86) PCT No.: PCT/EP2023/060066

§ 371 Date: Oct. 18, 2024

(30) Foreign Application Priority Data
Apr. 28, 2022 (DE) 10 2022 204 131.3

(51) Int. Cl. B25F 5/00

(52) U.S. Cl. CPC B25F 5/001

(57) ABSTRACT

A spindle locking device for locking a spindle of a hand-held power tool includes a locking element with a first locking position designed to lock the spindle, and a first operating position, in which the locking element is designed to release the spindle. A spring element is designed to press the locking element into the first locking position. A switching element in a second operating position is provided counter to a spring force of the spring element in order to hold, in particular interlockingly hold, the locking element in the first operating position. The spindle locking device has a guide which guides the switching element along a guide path between the second operating position and a second locking position in which the switching element releases the locking element. The guide path extends transversely to a direction of movement of the locking element.

### PRIOR ART

A spindle locking device has already been proposed, for locking a spindle of a hand-held power tool, said device comprising: a locking element which has a locking position, in which the locking element is designed to lock the spindle, and an operating position, in which the locking element is designed to release the spindle, a spring element which is designed to press the locking element into the locking position of the locking element, in which locking position a rotational movement of the spindle is prevented; and a switching element which, in at least one operating position is provided counter to a spring force of the spring element in order to hold, in particular interlockingly hold, the locking element in the operating position of the locking element.

### DISCLOSURE OF THE INVENTION

The invention is based on a spindle locking device for locking a spindle of a hand-held power tool, having a locking element which has a locking position, in which the locking element is set up to lock the spindle, and an operating position, in which the locking element is set up to release the spindle, having a spring element which is designed to press the locking element into the locking position of the locking element, in which a rotational movement of the spindle is prevented, and having a switching element which, in at least one operating position is provided counter to a spring force of the spring element in order to hold, in particular interlockingly hold, the locking element in the operating position of the locking element.

It is proposed that the spindle locking device has a guide via which the switching element can be guided along a guide path between the operating position and a locking position in which the switching element releases the locking element, wherein the guide path extends transversely to a direction of movement of the locking element.

A “spindle locking device” is to be understood as a device which is designed to self-lock a spindle in order to enable assembly and disassembly of an insert tool on the spindle. In particular, the spindle is locked so that the spindle does not rotate when a nut or threaded washer is tightened or loosened in order to enable assembly and disassembly of the insert tool. The term “designed” is to be understood in particular as specially designed and/or equipped. By the fact that an object is designed to perform a certain function, it should be understood in particular that the object fulfills and/or performs this certain function in at least one application and/or operating state. Preferably, the locking element is in its locking position when the switching element is arranged in its locking position. In the operating position of the locking element, the locking element is preferably free of contact with the spindle. The locking element is preferably designed in such a way that it prevents the rotational movement of the spindle in the locking position by means of interlocking. The locking element is preferably designed as a plate element. The locking element preferably delimits at least one passage opening. The passage opening preferably has a main plane of extension which is arranged parallel to a main plane of extension of the locking element. The passage opening is preferably completely enclosed by the locking element in at least one plane parallel to the main plane of extension of the passage opening. Preferably, the locking element delimits the passage opening in such a way that the passage opening is divided into two regions. The first region is preferably designed to release the spindle in the operating position. The second region is preferably designed to fix the spindle in the locking position. Preferably, the locking element is designed in such a way that the spindle is free from contact with the second region of the passage opening in the operating position of the locking element. Preferably, the locking element is designed in such a way that the spindle is arranged at least partially in the second region in the locking position of the locking element. Preferably, the second area is delimited by the locking element in such a way that it creates an interlocking connection with the spindle in the locking position of the locking element. It is conceivable that the interlocking connection between the second region of the locking element and the spindle has a clearance in the locking position of the locking element. In a design with a clearance, the interlocking is produced by a deflection, in particular by a rotational movement, of the spindle. Preferably, the play between the spindle and the locking element is designed in such a way that the spindle can rotate by a maximum of 30°, preferably by a maximum of 15° and particularly preferably by a maximum of 5° in a locking position of the locking element.

The spring element is preferably designed as a compression spring. Preferably, the locking element forms at least one protrusion. The protrusion is preferably designed to at least partially hold the spring element. The protrusion preferably has at least one shoulder. The spring element completely encloses the protrusion in at least one plane perpendicular to the main plane of extension of the locking element. Preferably, the protrusion accommodates the spring element. The spring element is preferably designed to be deflected in the direction of movement of the locking element. The shoulder is preferably designed to transfer a spring force of the spring element to the locking element. The spindle locking device is preferably designed in such a way that the spring is compressed when the switching element is moved from the locking position to the operating position of the switching element. A “guide path” is to be understood in particular as a path between two points that is predefined by at least one component and on which an object can be repeatedly moved between the two points, guided by the at least one component. By the fact that the guide path extends transversely to the direction of movement of the locking element, it should be understood in particular that the guide path extends in a plane which is arranged parallel to the main plane of extension of the locking element and has a main direction of extension which extends essentially perpendicular to the direction of movement of the locking element. A “main direction of extension” of an object is understood to be a direction that extends parallel to the longest edge of a smallest geometric cuboid that just completely encloses the object. The expression “essentially perpendicular” is intended here in particular to define an orientation of a direction relative to a reference direction, wherein the direction and the reference direction, in particular viewed in a projection plane, include an angle of 90° and the angle has a maximum deviation of in particular less than 25°, advantageously less than 15° and particularly advantageously less than 5°.

Preferably, the switching element has at least one detent shoulder. The detent shoulder is designed to press the locking element, against the spring force of the spring, into an operating position of the locking element when the switching element is guided from the locking position into the operating position of the switching element. Preferably, the detent shoulder of the switching element extends essentially from the switching element in the direction of the locking element. Preferably, the locking element also has a locking shoulder. The detent element of the locking element preferably extends from the locking element in the direction of the switching element.

The design of the spindle locking device according to the invention can advantageously provide a self-locking spindle locking device which is switched between a locking position and an operating position, wherein the device advantageously remains in the selected position until a user switches to another position. This makes it possible for a user to have both hands available to assemble or disassemble an insert tool on the spindle. An advantageously user-friendly and ergonomic spindle locking device can be provided. A spindle locking device can be provided which is advantageously free of rotating parts, making the spindle locking device advantageously robust. An advantageously compact spindle locking device can be provided.

Furthermore, it is proposed that the guide path has at least one tangent which is arranged in a plane of movement of the locking element at an angle of between 10° and 90° to the direction of movement of the locking element. The plane of movement is preferably aligned parallel to the main plane of extension of the locking element. The guide path is preferably curved when viewed in the plane of movement. Preferably, each tangent of the curved guide path arranged in the plane of movement has an angle of between 10° and 90° to the direction of movement of the locking element. Preferably, the angle between the at least one tangent, in particular each tangent of the guide path in the plane of movement, is between 50° and 90°, preferably between 60° and 90°, particularly preferably between 70° and 90° and preferably particularly preferably between 80° and 90°. The design of the spindle locking device makes it possible to provide a locking device for a spindle which is advantageously free of a rotatable bearing. An advantageously compact spindle locking device can be provided, which has an advantageously short and compact actuation path.

It is further proposed that the spindle locking device has a guide element, in particular a plate-shaped guide element, whose main plane of extension is arranged parallel to the plane of movement of the locking element and is designed to guide the locking element and the switching element in a plane perpendicular to an axis of rotation of the spindle. Preferably, the guide element is at least in contact with the locking element when the spindle locking device is assembled. When assembled, the guide element is preferably at least in contact with the locking element and the switching element. Preferably, the guide element has a guide side which is in contact with both the locking element and the switching element when the spindle locking device is assembled. Preferably, the guide element is designed as a plate element. Preferably, the guide element has a smaller height extension than the locking element. In this context, a “height extension” is to be understood in particular as a maximum extension of an object perpendicular to the main plane of extension of the object. Preferably, the guide element is in contact with the locking element and the switching element on the same side when the spindle locking device is assembled. The design of the spindle locking device makes it possible to provide an advantageously robust guide for a switching element and a locking element with advantageously few components.

Furthermore, a tool holder for the hand-held power tool is proposed, with the spindle locking device, which has the spindle for holding an insert tool and the at least partially hollow cylindrical bearing flange, which forms part of a guide of the spindle locking device, via which the switching element can be guided along a guide path. Preferably, the spindle has at least one groove. Preferably, the spindle has two grooves that run parallel to each other and are identical to each other. The at least one groove is preferably designed in such a way that a main direction of extension of the at least one groove is parallel to the direction of movement of the locking element in at least one position of the spindle. The at least one groove is preferably designed to be used in the locking position of the locking element.

The spindle and the locking element, in particular the second region of the locking element, form the interlocking connection between the spindle and the locking element. Preferably, the first region of the locking element has a longer extension in its main plane of extension in each spatial direction than a maximum diameter of the spindle, in particular than a maximum diameter of a part of the spindle which extends through the passage opening in the assembled state of the tool holder. Preferably, the second region of the locking element in the plane of movement in the direction perpendicular to the direction of movement of the locking element has a smaller maximum transverse extension than a minimum diameter of the spindle. Preferably, the at least one groove is designed to receive at least a part of the locking element in the locking position of the locking element. Preferably, the bearing flange has at least one shoulder extending radially inwards, which is designed to at least partially hold the spring element. Preferably, the spindle has an insert tool holder. The insert tool holder preferably has a thread for screwing in the insert tool. However, other types of attachment for the insert tool to the insert tool holder are also conceivable. The guide element is arranged downstream of the locking element in the direction of the spindle's axis of rotation, looking from the insert tool holder to the locking element. By the fact that the bearing flange is at least partially hollow cylindrical, it should be understood in particular that the bearing flange has at least one region which forms part of a hollow cylinder. Preferably, the bearing flange has an inner side, which is at least designed to guide the switching element along the inner side. Preferably, the inner side in the guide region of the switching element is cylindrical, in particular circular. However, it is also conceivable that the inner side in the guide region of the switching element, which at least partially guides the switching element, is flat. A guide region on the inner side of the bearing flange is to be understood in particular as the region of the bearing flange which is in contact with a side of the switching element facing away from the locking element during the guidance of the switching element from the locking position into the operating position. The design can provide a tool holder that is advantageously self-locking. A compact and user-friendly insert tool change can be provided as an advantage. An advantageously robust tool holder can be provided.

It is also proposed that the switching element is designed in one piece and extends from an interior delimited by the bearing flange into an operating environment. An interior of the bearing flange is to be understood in particular as a space delimited by the bearing flange, which is completely enclosed by the bearing flange in the plane perpendicular to the axis of rotation of the spindle. In this context, an “operating environment” is to be understood in particular as the environment of the hand-held power tool, in particular the tool holder, which is accessible to a user when the hand-held power tool, in particular the tool holder, is assembled. By the fact that the switching element extends from the interior into the operating environment, it should be understood in particular that in the assembled state of the tool holder, the switching element is arranged partly in the interior and partly in the operating environment. The switching element preferably has a base body which is arranged in the interior of the bearing flange. The switching element preferably has an operating element that extends from the base body into the operating environment. The operating element preferably has a main direction of extension that is parallel to the axis of rotation of the spindle. The design of the tool holder makes it possible to provide an advantageously user-friendly device. Advantageously, a simple and uncomplicated locking device for a spindle can be provided.

Furthermore, it is proposed that the bearing flange delimits at least one guide opening, which in particular connects the interior and the operating environment with each other, which forms part of the guide of the spindle locking device and is designed to guide the switching element in the guide path. Preferably, the guide opening has the same curvature as the guide region on the inner side when viewed in the direction of the spindle's axis of rotation. Preferably, the guide opening is designed to guide at least part of the operating element of the switching element in the guide path. Preferably, boundaries that delimit the guide opening longitudinally serve as the end for the guide path of the switching element. The base body of the switching element preferably has a larger maximum transverse extension than the guide opening. The design of the tool holder can advantageously provide a robust guide for a switching element. An advantageously simple guide for the switching element can be provided.

It is further proposed that the bearing flange has a shoulder extending radially into the interior, which is designed to guide the switching element in a plane perpendicular to the axis of rotation of the spindle. Preferably, the shoulder delimits the guide opening. The guide of the switching element is preferably formed at least by the bearing flange and the guide element. In particular, the guide is made up of several parts. Preferably, the guide consists of the guide region of the bearing flange, the shoulder of the bearing flange, the guide opening and the guide element. The design of the tool holder can advantageously provide a robust guide for a switching element. An advantageously simple guide for the switching element can be provided.

Furthermore, an assembly method for assembling the tool holder is proposed in which, in a first assembly step, a switching element is guided from the interior through a guide opening at least partially into an operating environment until the switching element bears against a shoulder of a bearing flange. Furthermore, it is proposed that in a second assembly step, a locking element is guided from an interior of the bearing flange to the switching element until the locking element bears against the switching element. Furthermore, it is proposed that in a third assembly step, a guide element is guided from the interior of the bearing flange in the direction of the switching element until the guide element bears against the switching element and the locking element. Thanks to the design of the assembly method, a tool holder can be mounted advantageously simply in just a few assembly steps.

The spindle locking device according to the invention, the tool holder according to the invention and the assembly method according to the invention for assembling a tool holder should not be limited to the application and embodiment described above. In particular, the spindle locking device according to the invention, the tool holder according to the invention and the assembly method according to the invention for assembling a tool holder to fulfill a mode of operation described herein may have a number of individual elements, components and units as well as method steps that differs from a number mentioned herein. In addition, in the case of the value ranges specified in this disclosure, values lying within the stated delimits are also to be regarded as disclosed and as usable as desired.

### DRAWINGS

Further advantages follow from the description of the drawings hereinafter. An exemplary embodiment of the invention is shown in the drawing. The drawing, the description and the claims contain numerous features in combination. The person skilled in the art will also usefully consider the features individually and combine them into useful further combinations.

Shown are:

FIG. 1 a tool holder according to the invention with a spindle locking device according to the invention in an operating position in a schematic representation,

FIG. 2 schematic representation of the tool holder according to the invention with the spindle locking device according to the invention in a locking position,

FIG. 3 the tool holder according to the invention with the spindle locking device according to the invention in a schematic sectional view and

FIG. 4 a schematic representation of an assembly method according to the invention.

### DESCRIPTION OF THE EXEMPLARY EMBODIMENT

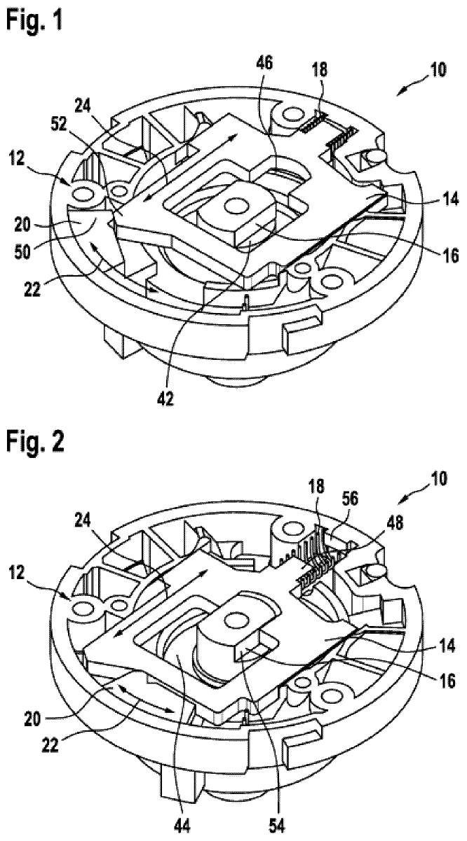

FIG. 1 shows a spindle locking device 12 for locking a spindle 16 of a hand-held power tool, said device comprising: a locking element 14 which has a locking position, in which the locking element 14 is designed to lock the spindle 16, and an operating position, in which the locking element 14 is designed to release the spindle 16. The spindle locking device 12 has a spring element 18 which is designed to press the locking element 14 into the locking position of the locking element 14, in which locking position a rotational movement of the spindle 16 is prevented. The spindle locking device 12 has a switching element 20 which, in at least one operating position is provided counter to a spring force of the spring element 18 in order to hold, in particular interlockingly hold, the locking element 14 in the operating position of the locking element 14. The spindle locking device 12 has a guide by means of which the switching element 20 can be guided along a guide path 22 between the operating position and a locking position in which the switching element 20 releases the locking element 14, wherein the guide path 22 extends transversely to a direction of movement 24 of the locking element 14. In FIG. 1, the locking element 14 and the switching element 20 are each shown in the operating position. FIG. 2 shows the switching element 20 and the locking element 14 in their locking positions. The locking element 14 is in its locking position when the switching element 20 is arranged in its locking position. In the operating position of the locking element 14, the locking element 14 is free from contact with the spindle 16. The locking element 14 is designed in such a way that it prevents the rotational movement of the spindle 16 in the locking position by means of interlocking. The locking element 14 is designed as a plate element. The locking element 14 delimits a passage opening 42. The passage opening 42 has a main plane of extension which is arranged parallel to a main plane of extension of the locking element 14. The passage opening 42 is completely covered by the locking element 14 in at least one plane parallel to the main plane of extension of the passage opening 42. The locking element 14 delimits the passage opening 42 in such a way that the passage opening 42 is divided into two regions 44, 46. A first of the two regions 44 is arranged in the direction of movement 24 of the locking element 14 on a side of the passage opening 42 facing the switching element 20. A second of the two regions 46 is arranged downstream of the first region 44 in a viewing direction from the switching element 20 in the direction of movement 24 of the locking element 14. The first region 44 is designed to release the spindle 16 in the operating position. The second region 46 is designed to fix the spindle 16 in the locking position. The locking element 14 is designed in such a way that the spindle 16 is free from contact with the second region 46 of the passage opening 42 in the operating position of the locking element 14. The locking element 14 is designed in such a way that the spindle 16 is arranged at least partially in the second region 46 in the locking position of the locking element 14. The second region 46 is delimited by the locking element 14 in such a way that it creates an interlocking connection with the spindle 16 when the locking element 14 is in the locking position. The spring element 18 is designed as a compression spring. The locking element 14 forms a protrusion 48. The protrusion 48 is designed to at least partially hold the spring element 18. The protrusion 48 has two shoulders. The shoulders are arranged on two parallel sides of the protrusion 48 and extend in opposite directions. The spring element 18 completely surrounds the protrusion 48 in at least one plane perpendicular to the main plane of extension of the locking element 14. The spring element 18 is designed to be deflected in the direction of movement 24 of the locking element 14. The shoulder is designed to transfer a spring force of the spring element 18 to the locking element 14. The spindle locking device 12 is designed in such a way that the spring element 18 is compressed when the switching element 20 is moved from the locking position into the operating position of the switching element 20. The switching element 20 has a detent shoulder 50. The detent shoulder 50 is designed to press the locking element 14, in particular against the spring force of the spring element 18, into an operating position of the locking element 14 when the switching element 20 is guided from the locking position into the operating position of the switching element 20. The detent shoulder 50 of the switching element 20 extends essentially from the switching element 20 in the direction of the locking element 14. The locking element 14 also has a detent shoulder 52. The detent shoulder 52 of the locking element 14 extends from the locking element 14 in the direction of the switching element 20. The guide path 22 has at least one tangent, which is arranged in a plane of movement of the locking element 14 at an angle to the direction of movement 24 of the locking element 14, which is between 10° and 90°. The plane of movement is aligned parallel to the main plane of extension of the locking element 14. The guide path 22 is curved in the plane of movement.

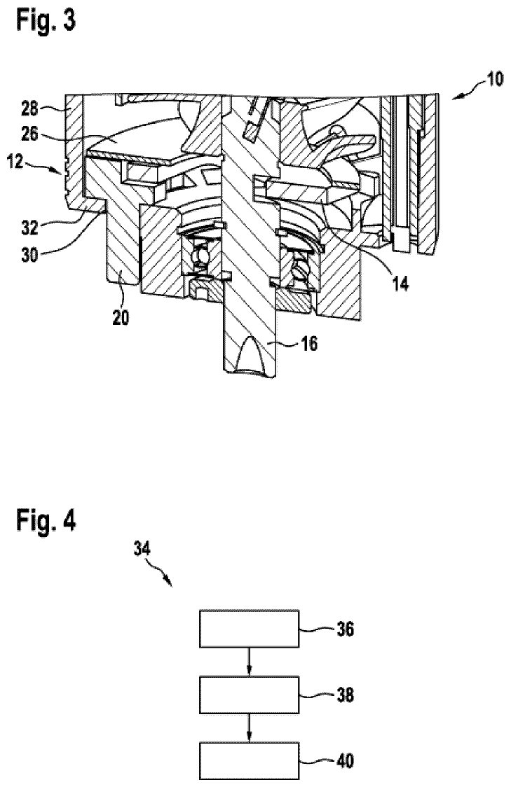

The spindle locking device 12 has a guide element 26, in particular a plate-shaped guide element, whose main plane of extension is arranged parallel to the plane of movement of the locking element 14 and is designed to guide the locking element 14 and the switching element 20 in a plane perpendicular to an axis of rotation of the spindle 16. When the spindle locking device 12 is assembled, the guide element 26 is at least in contact with the locking element 14. When assembled, the guide element 26 is in contact with the locking element 14 and the switching element 20. The guide element 26 has a guide side which is in contact with both the locking element 14 and the switching element 20 when the spindle locking device 12 is assembled. The guide element 26 is designed as a plate element. The guide element 26 has a smaller height extension than the locking element 14. In the assembled state of the spindle locking device 12, the guide element 26 is in contact with the locking element 14 and the switching element 20 on one side (FIG. 3).

FIG. 3 shows a tool holder 10 for a hand-held power tool, with the spindle locking device 12. The tool holder 10 has the spindle 16 for holding an insert tool and an at least partially hollow cylindrical bearing flange 28, which forms part of a guide of the spindle locking device 12, via which the switching element 20 can be guided along a guide path 22. The spindle 16 has two grooves 54, which extend parallel to each other and are identical to each other. The two grooves 54 are formed such that a main direction of extension of the grooves 54 is formed parallel to the direction of movement 24 of the locking element 14 in at least one position of the spindle 16. The two grooves 54 are designed to form the interlocking connection between the spindle 16 and the locking element 14, in particular the second region 46 of the locking element 14, in the locking position of the locking element 14. The first region 44 of the locking element 14 has a longer extension in its main plane of extension in each spatial direction than a maximum diameter of the spindle 16, in particular than a maximum diameter of a part of the spindle 16 which extends through the passage opening 42 in the assembled state of the tool holder 10. The second region 46 of the locking element 14 has a smaller maximum transverse extension in the plane of movement in the direction perpendicular to the direction of movement 24 of the locking element 14 than a minimum diameter of the spindle 16. The grooves 54 are designed to hold at least a part of the locking element 14 in the locking position of the locking element 14. The bearing flange 28 has a radially inwardly extending shoulder 56, which is designed to at least partially hold the spring element 18. The spindle 16 has an insert tool holder. The insert tool holder has a thread for screwing in the insert tool. However, it is also conceivable that the insert tool holder has another design that would appear useful to a person skilled in the art, which is set up to accommodate an insert tool, for example a thread on an outer side of the spindle 16. The guide element 26 is arranged downstream of the locking element 14 in the direction of the axis of rotation of the spindle 16 as viewed from the insert tool holder to the locking element 14. The bearing flange 28 has an inner side, which is at least designed to guide the switching element 20 along the inner side. The inner side is cylindrical, in particular circular, in the guide region of the switching element 20.

The switching element 20 is formed in one piece and extends from an interior delimited by the bearing flange 28 into an operating environment. The switching element 20 has a base body which is arranged in the interior of the bearing flange 28. The switching element 20 has an operating element that extends from the base body into the operating environment. The operating element has a main direction of extension that is parallel to the axis of rotation of the spindle 16. The bearing flange 28 delimits a guide opening 30, which in particular connects the interior and the operating environment with one another, which forms part of the guide of the spindle locking device 12 and is designed to guide the switching element 20 in the guide path 22. Viewed in the direction of the axis of rotation of the spindle 16, the guide opening 30 has the same curvature as the guide region on the inner side. The guide opening 30 is designed to guide at least part of the operating element of the switching element 20 in the guide path 22. The boundaries that longitudinally delimit the guide opening 30 serve as the end for the guide path 22 of the switching element 20. The base body of the switching element 20 has a larger maximum transverse extension than the guide opening 30. The bearing flange 28 has a shoulder 32 extending radially into the interior, which is designed to guide the switching element 20 in a plane perpendicular to the axis of rotation of the spindle 16. The shoulder 32 delimits the guide opening 30. The guide of the switching element 20 is formed at least by the bearing flange 28 and the guide element 26. The guide consists of the guide region of the bearing flange 28, the shoulder 32 of the bearing flange 28, the guide opening 30 and the guide element 26 (FIG. 3).

An assembly method 34 for assembling the tool holder 10 is described below with reference to FIGS. 3 and 4. In a first assembly step 36, the switching element 20 is guided from the interior through a guide opening 30 at least partially into an operating environment until the switching element 20 bears against the shoulder 32 of the bearing flange 28. In a second assembly step 38, the locking element 14 is guided from an interior of the bearing flange 28 to the switching element 20 until the locking element 14 bears against the switching element 20. In a third assembly step 40, the guide element 26 is guided from the interior of the bearing flange 28 in the direction of the switching element 20 until the guide element 26 bears against the switching element 20 and the locking element 14.

1. A spindle locking device for locking a spindle (16) of a hand-held power tool, comprising:
a locking element which has a first locking position, in which the locking element is designed to lock the spindle and an a first operating position, in which the locking element is designed to release the spindle;
a spring element designed to press the locking element into the first locking position in which first locking position a rotational movement of the spindle is prevented; and
a switching element which, in at least one second operating position is provided counter to a spring force of the spring element order to hold, in particular interlockingly hold the locking element in the first operating position wherein
a guide configured to guide the switching element along a guide path between the at least one second operating position and a second locking position in which the switching element releases the locking element, and
the guide path extends transversely to a direction of movement of the locking element.

2. The spindle locking device according to claim 1, wherein the guide path has at least one tangent which is arranged in a plane of movement of the locking element at an angle to the direction of movement of the locking element which is between 10° and 90°.

3. The spindle locking device according to claim 1, wherein a plate-shaped guide element a main plane of extension of which is arranged parallel to a plane of movement of the locking element, and is designed to guide the locking element and the switching element in a plane perpendicular to an axis of rotation of the spindle.

4. A tool holder for a hand-held power tool, having a spindle locking device according to one claims claim 1, comprising:
a spindle configured to hold an insert tool; and
an at least partially hollow-cylindrical bearing flange, which forms part of the guide of the spindle locking device, via which the switching element is guided along the guide path.

5. The tool holder according to claim 4, wherein the switching element is formed in one piece and extends from an interior delimited by the bearing flange into an operating environment.

6. The tool holder according to claim 5, wherein the bearing flange delimits at least one guide opening, which connects the interior and the operating environment with one another, which forms part of the guide of the spindle locking device and is designed to guide the switching element in the guide path.

7. The tool holder according to claim 5, wherein the bearing flange has a shoulder which extends radially into the interior and is designed to guide the switching element in a plane perpendicular to the axis of rotation of the spindle.

8. An assembly method for assembling a tool holder according to claim 5, comprising:
guiding a switching element (20) is guided from the interior through a guide opening at least partially into an the operating environment until the switching element bears against a shoulder of a bearing flange.

9. The assembly method according to claim 8, further comprising:
guiding a locking element (14) is guided from an interior of the bearing flange toward the switching element until the locking element bears against the switching element.

10. The assembly method according to claim 9, further comprising:
guiding guide element from the interior of the bearing flange in the direction of the switching element until the guide element bears against the switching element and the locking element.
